(19) United States
(12) Patent Application Publication
(10) Pub. No.: US 2007/0294626 A1
(43) Pub. Date: Dec. 20, 2007

(54) CONTROLLING APPLICATION SHARING

(75) Inventors: Joseph T. Fletcher, Seattle, WA (US); Cameron J. Parker, Sammamish, WA (US); Sergei Osobov, Redmond, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/424,320

(22) Filed: Jun. 15, 2006

(51) Int. Cl. G06F 3/00

(52) U.S. Cl. 715/751

(57) ABSTRACT

A facility is provided for controlling application sharing. In various embodiments, the facility shares an application from a sharer computing device to a viewer computing device so that the viewer computing device displays information that the sharer computing device displays, receives an indication from the first viewer computing device to control the sharing, and transfers control of the shared application to the viewer computing device without intervention by a user of the sharer computing device so that a user of the viewer computing device can control the shared application.

### BACKGROUND

People sometimes use application sharing software to share documents or applications. Application sharing software enables a sharer to share display information from the sharer's computing device to other computing devices that are used by participants in an application sharing session. The other computing devices can be referred to as viewer computing devices. When a sharer shares a document or application with participants, the sharer computing device and the viewer computing devices may display identical or similar information during the application sharing session. As an example, the computing devices may display the same applications, documents, or other images.

Application and document sharing has various uses. As an example, a participant can view on a viewer computing device changes made by a sharer to a document at the sharer computing device. Application sharing also enables a sharer to let a participant control an application that is executing on the sharer computing device. As an example, a sharer can enable a participant (e.g., a helpdesk technician) to control the shared application via the participant's computing device. Application sharing can also be used in collaborative environments so that, for example, multiple users can work on a document together.

When an application or document is shared at a sharer computing device, application sharing software operating on the sharer computing device provides data or display information from the sharer computing device to application sharing software operating on viewer computing devices so that the participants can view what the sharer views and shares. As an example, the application sharing software can interface with the graphical device interface (“GDI”) of the operating system to transmit to the viewer computing devices calls made to the GDI by the application that is shared or the application displaying the document that is shared. The GDI is an operating system component that transforms data or drawing commands into data suitable for display on a display device. Upon receiving indications of the GDI calls sent by the sharer computing device, application sharing software operating on the viewer computing devices makes similar calls so that the viewer computing devices show identical or similar information. As another example, the application sharing software can interface with the GDI to capture changes to the sharer computing device's display device and send indications of the changes to the connected viewer computing devices so that they too can display the same or similar changes on their display devices. This technique is commonly referred to as “screen scraping.”

Conventionally, the sharer controls the application sharing session. As an example, the sharer decides whether and when to relinquish control of a shared application to a participant, which participant to relinquish control to, and when to retake control. When multiple participants desire control, the sharer can decide to which participant to give control. Generally, participants request control using auditory, visual, or other cues. As an example, a participant may request control by speaking into a telephone, typing in text in a chat window, or selecting a “Request control” command that notifies the sharer that the participant is requesting control. The sharer can then revoke control from the participant with control and give control to the requesting participant. However, this manual “baton passing” by the sharer can get in the way of natural collaboration. As an example, when multiple participants are collaborating, one participant cannot easily give control to another participant because the sharer decides which participant is to be in control and makes a corresponding indication to the application sharing software. As a result, participants suspend collaborating while the sharer reconfigures the application sharing software to provide control to a selected participant, which gets in the way of natural collaboration because work stops while the sharer revokes control from one participant to provide control to another participant.

### SUMMARY

A facility is described for controlling application sharing. The facility enables a user to request control of an application that is shared during an application sharing session and provides control to the requesting user at an appropriate time. Users can request control of the application by providing input to their computing devices indicating a request for control. Once a user's computing device receives control, that user becomes the “controller” of the application. An arbiter, which is a software component, can select a computing device that will receive control on a first-in-first-out basis or some other manner, such as by using a priority. Once the arbiter selects a computing device that is to be provided control, it provides a notification to the computing devices participating in the application sharing session indicating the new controller. Thus, the facility enables users to receive control without user input from a sharer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating a computing environment in which the facility operates in some embodiments.

FIGS. 2A-2D are display diagrams illustrating aspects of user interfaces provided by the facility in various embodiments.

FIG. 3 is a display diagram illustrating an aspect of the user interface provided by the facility in some embodiments.

FIG. 4 is a block diagram illustrating components associated with the facility in various embodiments.

FIG. 5 is a flow diagram illustrating a request_control routine invoked by the facility in various embodiments.

FIG. 6 is a flow diagram illustrating a receive_request_control routine invoked by the facility in various embodiments.

FIG. 7 is a flow diagram illustrating a process_request_control routine invoked by the facility in various embodiments.

FIG. 8 is a flow diagram illustrating a handle_control routine invoked by the facility in various embodiments.

FIG. 9 is a control flow diagram illustrating control acquisition in various embodiments.

FIG. 10 is a control flow diagram illustrating control transfer in various embodiments.

### DETAILED DESCRIPTION

A facility is described for controlling application sharing. In various embodiments, the facility enables a user to request control of an application that is shared during an application sharing session and provides control to the requesting user at an appropriate time without intervention by the sharer. In various embodiments, users (e.g., participants or the sharer) can request control of the application by providing input to their computing devices, such as by clicking a mouse button or typing, moving a mouse pointer, selecting an option to request control, or providing some other indication to request control. As an example, a user can select an option in an application sharing software running on a viewer computing device, depressing a mouse button or typing while a mouse pointer or cursor is in the application sharing software or shared application, and so forth. The facility may then provide control of the shared application to the requesting user. Once a user's computing device receives control, that user becomes the “controller” of the application even though the application is shared by a sharer computing device. The controller can then control the shared application even though the shared application executes on a sharer computer device. A computing device can request control by sending a request control message to the sharer computing device or a sharing server, collectively referred to as an “arbiter.” A sharing server provides various services to an application sharing session, such as a directory of users or computing devices, message transmission and redirection, and so forth. The arbiter, which is a component of application sharing software, may store arriving request control messages, which identify the requesting computing device or requesting user, in a queue of control requests. The arbiter may then provide control to a requesting computing device when the controller relinquishes control. The controller can relinquish control either actively or passively. As examples, the controller can actively relinquish control by selecting an option or can passively relinquish control by failing to provide any input (e.g., via mouse, keyboard, voice, etc.) for a defined period of time, such as two seconds.

The arbiter can select a computing device that will receive control on a first-in-first-out basis or some other manner, such as by using a priority. As an example, the sharer or a particular participant (e.g., manager of a group of people or presenter of a presentation) may receive priority over other participants so that a participant with higher priority receives control before a participant with lower priority even though the participant with lower priority requested control first. Once the arbiter selects a computing device that is to be provided control, it can notify computing devices participating in the application sharing session, such as by sending an indication of the selected computing device in a controller change message. Upon receiving the controller change message from the arbiter, the computing devices can indicate to their users (e.g., sharer and participants) that a new controller has control of the application sharing session. Thus, by enabling users to request and take control without intervention of a sharer, application sharing becomes more collaborative because collaboration does not need to be paused so that the sharer can reconfigure application sharing by explicitly revoking control from one participant to grant it to another participant.

In various embodiments, the sharer can indicate whether participants can take control. As an example, when the sharer indicates that no participant can take control, control requests that participants send can either be ignored or handled manually by the sharer. Alternatively, the participants may receive an error message. In various embodiments, the facility can enable some participants to take control but not others. As an example, the sharer can indicate that only identified participants should be able to take control, such as participants having one or more “roles.” Then, when a participant who is not identified requests control, the facility can automatically deny that participant's request or can enable the sharer to manually provide control to that participant. As examples, a participant having a “presenter” role may be able to take control, but a participant having an “attendee” role may not be able to do so. In some embodiments, participants that are not identified as being able to request control may even be unable to make a request for control.

In various embodiments, the application sharing software's user interface can indicate who has control, who the sharer is, and so forth. The user interface may provide an indication that the controller is changing.

In various embodiments, a controller can explicitly yield control to another user or can return control to a prior controller. As an example, if a first participant takes control from a sharer and then a second participant takes control from the first participant, the arbiter may return control to the first participant when the second participant becomes inactive for a defined period of time and then to the sharer when the first participant becomes inactive. In various embodiments, the facility may transfer control from the second participant to the sharer. In various embodiments, the facility may provide control to a user providing input regardless of whether the active controller pauses for a defined amount of time.

In various embodiments, when the sharer provides input while a participant has control, the facility revokes control from the participant and provides it to the sharer. The participant (or viewer computing device) is identified in the queue as requesting control so that when the sharer relinquishes control, control is given to that participant who was previously the controller.

In various embodiments, the request control or controller change messages can identify a user rather than or in addition to identifying the computing device.

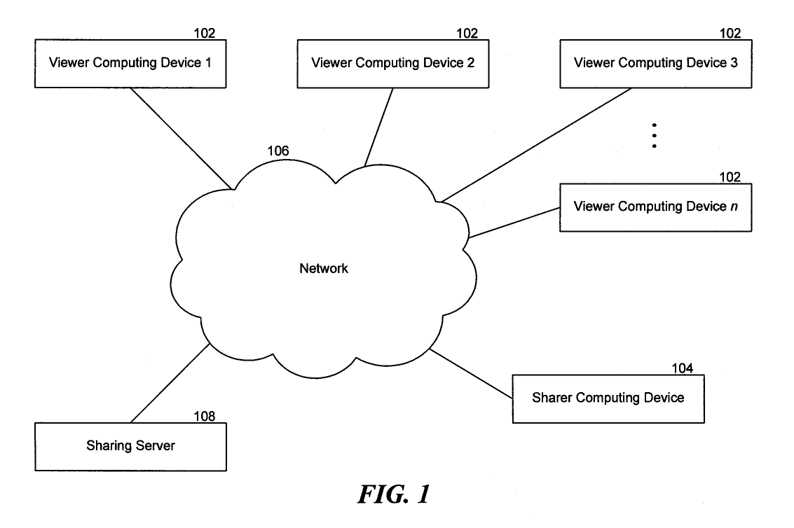

Turning now to the figures, FIG. 1 is a block diagram illustrating a computing environment in which the facility operates in some embodiments. The environment includes one or more viewer computing devices 102 and a sharer computing device 104. In various embodiments, multiple sharer computing devices can be used, such as when multiple application sharing sessions are operating. The viewer and sharer computing devices can be interconnected via a network 106, such as an intranet or the Internet. The environment may further include a sharing server 108.

The sharer computing device shares applications or documents with viewer computing devices so that an application or document that the sharer computing device displays is also displayed by the viewer computing devices. The viewer computing devices and the sharer computing device can participate in an application sharing session that is associated with an application sharing software.

The sharing server is a computer that provides additional services to the application sharing session, such as a directory of users and computing devices that are capable of participating in an application sharing session. The sharing server can also select one of several requesting participants to receive control.

A system for implementing the facility includes a general purpose computing device (“computer”). Components of the computer may include, but are not limited to, a processing unit, a system primary memory, a storage device, a network adapter or interface, a display, and input and output devices.

Computers typically include a variety of computer-readable media that are operable with storage devices connected thereto. Computer-readable media can be any available media that can be accessed by the computer and include both volatile and nonvolatile media and removable and nonremovable media.

The computer may operate in a networked environment using logical connections to one or more remote computers. A remote computer may be a personal computer, a server, a router, a network PC, a peer device, or other common network node, and typically includes many or all of the elements described above in relation to the computer. A logical connection can be made via a local area network (LAN) or a wide area network (WAN), but may also include other networks. Such networking environments are commonplace in homes, offices, enterprisewide computer networks, intranets, and the Internet. The computer can be connected to a network through a network interface or adapter, such as to a wired or wireless network.

The computer is only one example of a suitable computing environment and is not intended to suggest any limitation as to the scope of use or functionality of the facility. Neither should the computing system be interpreted as having any dependency or requirement relating to any one or a combination of the illustrated components.

The facility is operational with numerous other general purpose or special purpose computing systems or configurations. Examples of well-known computing systems, environments, and/or configurations that may be suitable for use with the facility include, but are not limited to, personal computers, server computers, handheld or laptop devices, cellular telephones, tablet devices, multiprocessor systems, microprocessor-based systems, set-top boxes, programmable consumer electronics, network PCs, minicomputers, mainframe computers, distributed computing environments that include any of the above systems or devices, and the like.

The facility may be described in the general context of computer-executable instructions, such as program modules, that are executed by a computer. Generally, program modules include routines, programs, objects, components, data structures, and so forth that perform particular tasks or implement particular abstract data types. The facility may also be employed in distributed computing environments where tasks are performed by remote processing devices that are linked through a communications network. In a distributed computing environment, program modules may be located in local and/or remote computer storage media, including memory storage devices.

While various functionalities and data are shown in the figures as residing on particular computer systems that are arranged in a particular way, those skilled in the art will appreciate that such functionalities and data may be distributed in various other ways across computer systems in different arrangements. While computer systems configured as described above are typically used to support the operation of the facility, one of ordinary skill in the art will appreciate that the facility may be implemented using devices of various types and configurations, and having various components.

The techniques may be described in the general context of computer-executable instructions, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

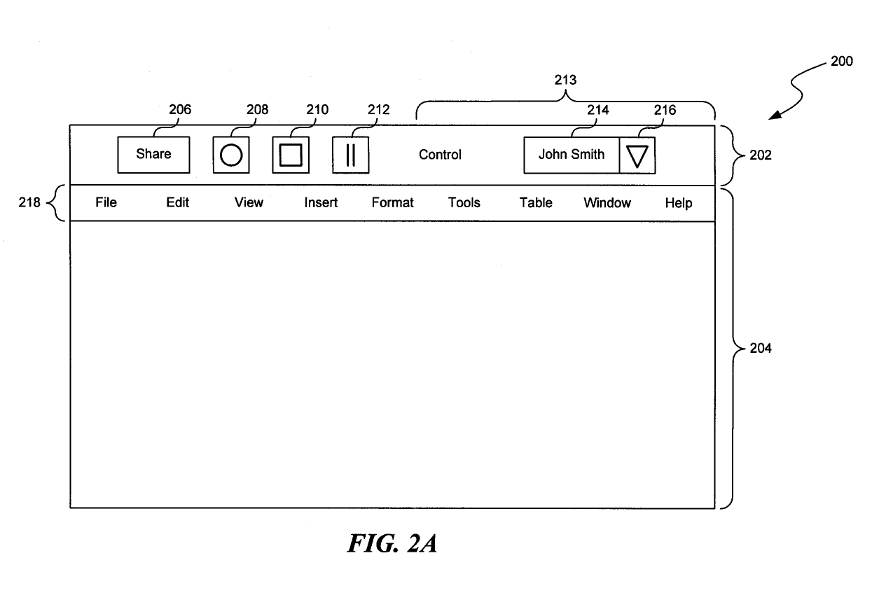

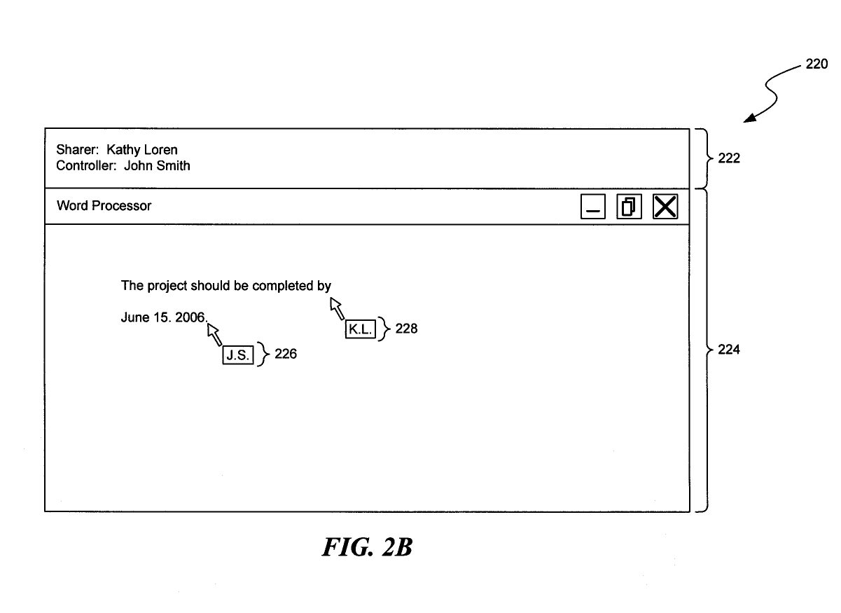

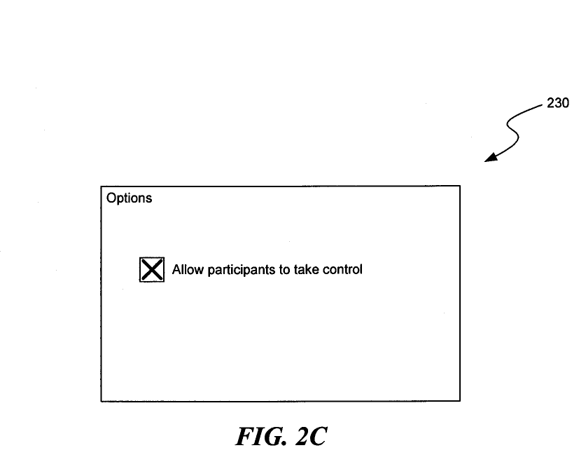

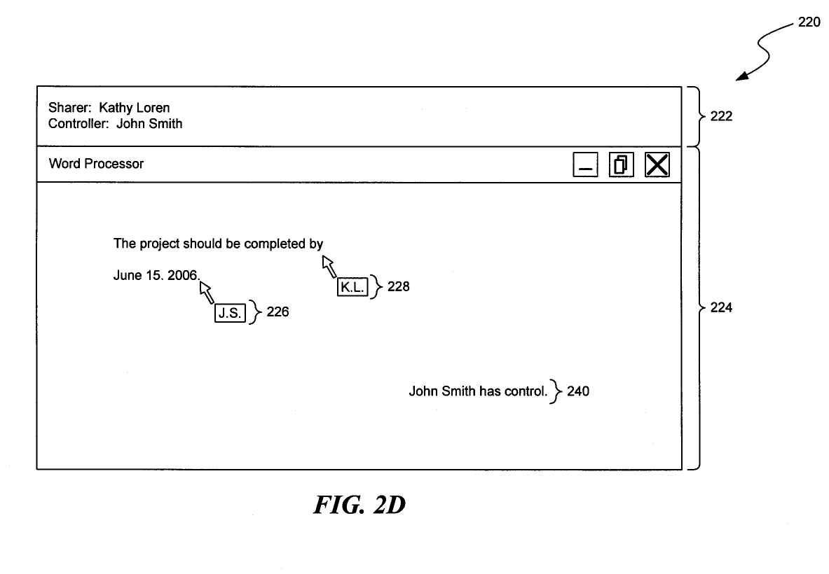

FIG. 2A is a display diagram illustrating an aspect of a user interface provided by the application sharing software. The user interface 200 includes a sharing region 202 and a shared application region 204. The sharing region includes controls that a user (e.g., sharer or controller of the shared application) can use to manipulate the application sharing session. As examples, the sharing region includes a share button region 206. The user can select the share button region to start or stop sharing of an application or document. The user can also employ a record button region 208 to record the sharing session, such as in a collaboration file. When a sharing session is recorded, the collaboration file can contain information that is shared or input that is provided by the sharer or participants, such as information that users type during the sharing session. Users may then be able to play back the recorded sharing session. The user can select a stop button region 210 to terminate the sharing session. The user can select a pause button region 212 to temporarily suspend the sharing session.

The sharing region also includes a control region 213 to enable the user to select a controller of the sharing session. As an example, the user can select a drop-down control region 216 to display a list of participants that the user can select. An identification of the selected controller would then appear in region 214. In various embodiments, the drop-down control region may indicate the participants that have requested control.

The shared application region 204 can include some or all portions of a shared application, such as a menu region 218, such as a menu provided by the shared application.

FIG. 2B is a display diagram illustrating a user interface of a shared application, such as when displayed by a viewer computing device operating an application sharing software. The user interface 220 includes a sharing region 222 and a shared application region 224. The sharing region indicates identifications of the sharer and the controller. The sharer identifies the person whose computing device is the sharer computing device. The controller identifies the person who is presently controlling the shared application. The shared application region displays the shared application. In various embodiments, the shared application region can include multiple cursors or mouse pointers. The mouse pointers can optionally indicate which users control the mouse pointers. As an example, the sharer's mouse pointer 228 includes the initials of the sharer so that participants can readily identify which user is controlling that mouse pointer. Similarly, the controller's mouse pointer 226 includes the initials of the controller. In various embodiments, the facility may identify mouse pointers and cursors using other means. As examples, the facility may identify the mouse pointers and cursors using colors, full names, or other commonly employed means to distinguish user interface elements. The user interface can also display other cursors, such as cursors controlled by other participants.

FIG. 2C is a display diagram illustrating an options user interface. A sharer can use the user interface 230 to indicate to the facility whether participants are allowed to take control of a sharing session. When a participant is not allowed to take control of the sharing session, the facility will not enable participants to automatically take control. In such a case, the facility may enable the participant to request control but may not provide control automatically, such as without manual intervention of the sharer.

FIG. 2D is a display diagram illustrating a user interface of a shared application, such as when displayed by a viewer computing device. The facility may display an identity of a controller when the controller changes. As an example, when John Smith takes control, the facility momentarily displays at region 240 that the controller has changed to John Smith. In various embodiments, the facility may display the change at other locations in the user interface.

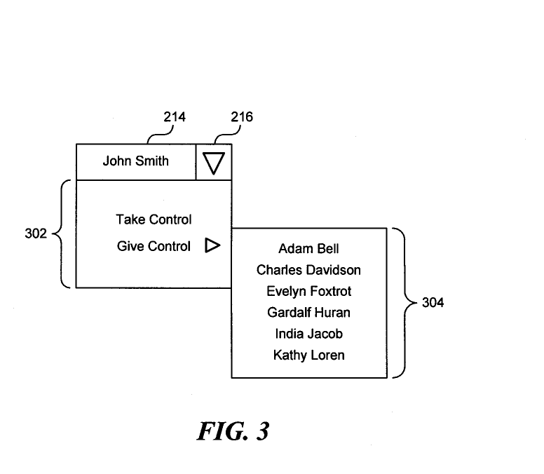

FIG. 3 is a display diagram illustrating an aspect of the user interface provided by the facility in some embodiments. When the user selects drop-down control region 216, the facility can display commands available to the user, such as to take or give control, in region 302. When the user selects the take control command, the facility can revoke control from the present controller and provide it to the user. The facility may wait until the present controller pauses before revoking control. In various embodiments, the facility can send a message to the sharer computing device indicating that the user requests control. In such a case, the facility may provide control to the user when the controller either yields control or pauses collaborating, such as by not providing any input for a defined period of time. When the user selects the give control command, the facility can display a list of participating users to whom control can be given, such as in region 304. When the user selects one of the identified users, the facility gives control to that user. Thus, a user can take or give control without the sharer having to manually identify who has control.

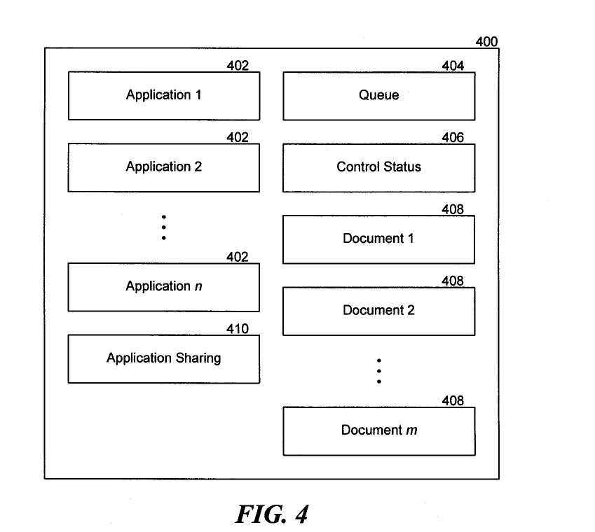

FIG. 4 is a block diagram illustrating components associated with the facility in various embodiments. The components 400 can operate in conjunction with an arbiter, such as a sharer computing device or a sharing server. The components can include one or more sharable applications 402, such as word processors, spreadsheet programs, business graphics presentation programs, and so forth. The components further include a queue 404 for storing control requests received from computing devices. The facility can also include a control status component 406 that stores an indication of the present controller, such as an identity of the controller's computing device or user. In various embodiments, the facility can also include documents 408 that the sharer computing device can share with viewer computing devices.

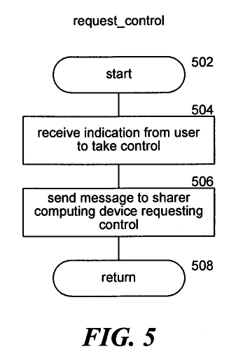

FIG. 5 is a flow diagram illustrating a request_control routine invoked by the facility in various embodiments. The facility invokes the request_control routine when it receives an indication from a user requesting control of the shared application. The routine may be performed by the user's computing device. The routine begins at block 502.

At block 504, the routine receives an indication from the user to take control of the shared application. The user may provide the indication by clicking a mouse button, selecting an option or command, typing, and so forth. The user may indicate to take control when, for example, the user desires to manipulate the shared application or document so that other participants and the sharer can readily identify actions the user desires to take.

At block 506, the routine sends a message to the sharer computing device requesting control. The message can include an identity of the user or the user's computing device.

At block 508, the routine returns.

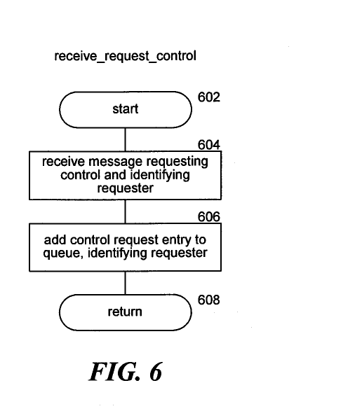

FIG. 6 is a flow diagram illustrating a receive_request_control routine invoked by the facility in various embodiments. The facility invokes this routine when it receives a message from a computing device requesting to take control. As an example, an arbiter can receive the message from a viewer computing device or a sharer computing device. The facility then acts on the received message. The routine begins at block 602.

At block 604, the routine receives a message requesting control and identifying the requester. The identification of the requester may include an identity of the requesting user, the requesting user's computing device, or both.

At block 606, the routine adds an indication of the control request to the queue. The indication can also include the received identification of the requester.

At block 608, the routine returns.

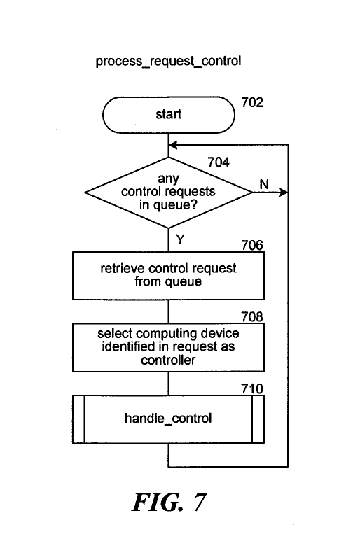

FIG. 7 is a flow diagram illustrating a process_request_control routine invoked by the facility in various embodiments. The facility invokes this routine to process the queued control requests. In various embodiments, the routine may be performed in an endless loop (e.g., during the sharing session) or can be invoked from time to time, such as periodically. The routine begins at block 702.

At block 704, the routine determines whether there are any pending control requests in the queue. When there are pending control requests in the queue, the routine continues at block 706. Otherwise, the routine either returns to block 704 when the routine is performed in an endless loop, or returns so that it can be invoked again later.

At block 706, the routine retrieves a pending control request from the queue. The control request can also include an identification of the requester that requested to take control. In various embodiments, the facility retrieves the control request in a first-in-first-out, last-in-first-out, random, or some other basis. In various embodiments in which priority is assigned to the incoming control requests (e.g., based on the identity of the requester), the facility may retrieve the highest priority control request from the queue.

At block 708, the routine selects the computing device identified in the control request as the next controller. In various embodiments, the routine may select the user or computing device identified in the control request as the next controller.

At block 710, the routine invokes a handle_control subroutine. The routine may provide the identification of the requester to the subroutine.

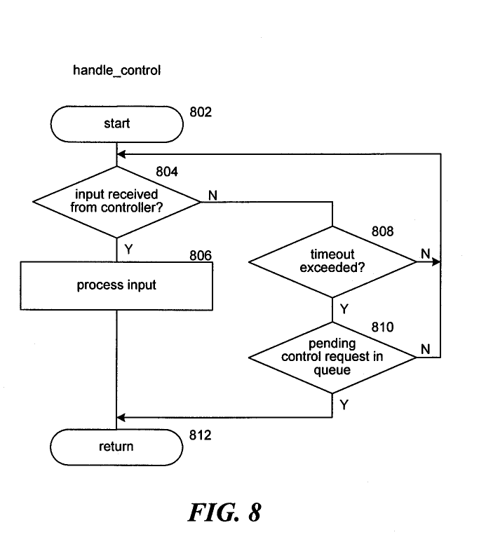

FIG. 8 is a flow diagram illustrating a handle_control routine invoked by the facility in various embodiments. The facility invokes the handle_control routine to process control requests that are retrieved from the queue. The routine can be performed by the arbiter. The routine begins at block 802.

At block 804, the routine determines whether input has been received from the controller. Input can include keyboard, mouse, voice, or other input that a user is capable of providing to a computing device. When the controller has provided input, the routine continues at block 806. Otherwise, the routine continues at block 808. The routine is able to distinguish input provided by a controller from input provided by the sharer by using low-level operating system hooks, such as WH_KEYBOARD, WH_KEYBOARD_LL, WH_MOUSE, and WH_MOUSE_LL hooks available in the MICROSOFT WINDOWS operating system. By integrating with these operating system hooks, the facility can determine whether the mouse and keyboard input was provided locally (e.g., by the sharer) or remotely (e.g., by the controller). The facility can distinguish who provided the input so that it can revoke control when the controller provides no input prior to a defined timeout.

At block 806, the routine processes the received input. As an example, the routine can provide the received input to the shared application.

At block 808, the routine determines whether a timeout has been exceeded. The timeout can be a defined period of time, such as two seconds. This period of time can be predetermined or can be configured by a user, such as an administrator or the sharer. If the timeout has been exceeded, the routine continues at block 810. Otherwise, the routine continues at block 804. Thus, when the timeout has not been exceeded, the routine continues to process input received from the controller, and the timeout is reset.

At block 810, the routine determines whether there are any pending control requests in the queue. When there are no further pending requests, the routine continues at block 804. Otherwise, the routine continues at block 812. Thus, even though the timeout may have been exceeded, control does not need to transfer to another user unless a control request is pending.

At block 812, the routine returns.

Those skilled in the art will appreciate that the steps shown in FIGS. 5-8 and discussed above may be altered in various ways. For example, the order of the logic may be rearranged, substeps may be performed in parallel, shown logic may be omitted, other logic may be added, etc.

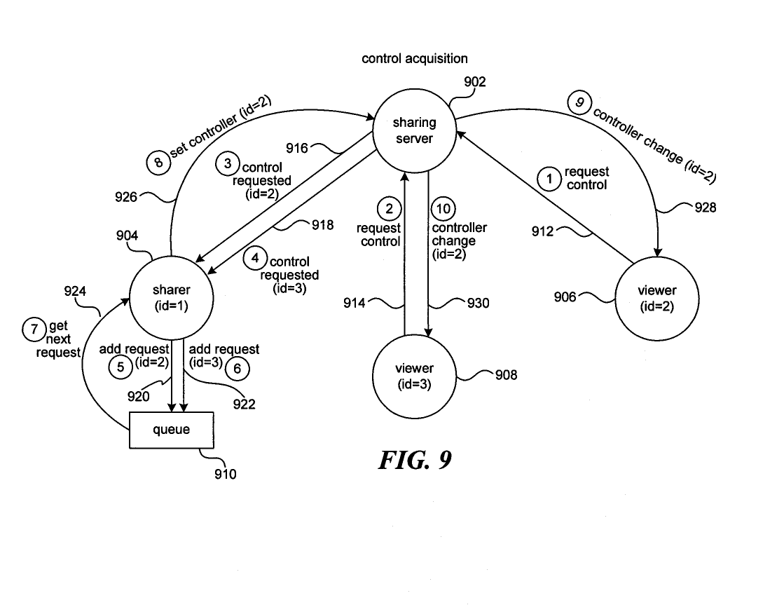

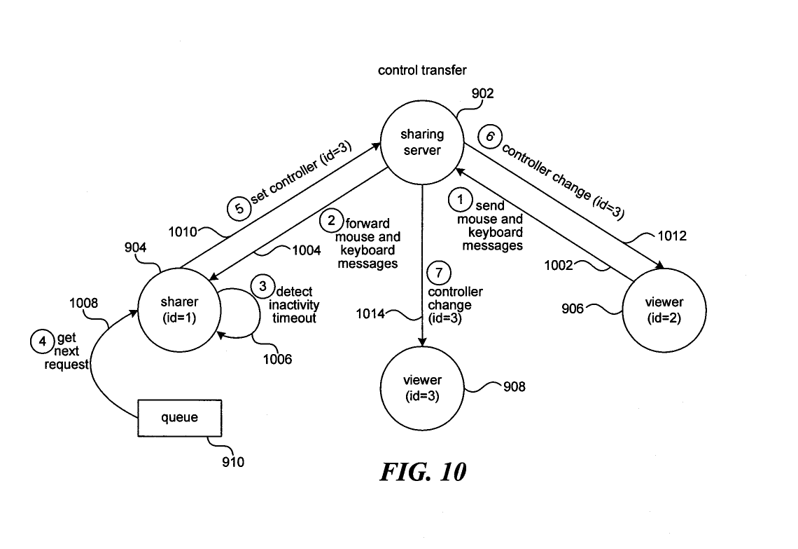

FIGS. 9-10 are control flow diagrams. The illustrated embodiment includes a sharing server 902, sharer computing device 904, and viewer computing devices 906 and 908. The sharer computing device is provided an identity of 1, and viewer computing devices 906 and 908 are provided identities 2 and 3, respectively. In various embodiments, the identities may relate to users rather than computing devices.

FIG. 9 is a control flow diagram illustrating control acquisition in various embodiments. The illustrated control flow corresponds to acquisition of control by a viewer computing device that is participating in an application sharing session in which a different computing device presently has control. The viewer computing device 906 sends a request control message 912 to the sharing server. The message includes the identity of the viewer computing device. The viewer computing device 908 also sends a request control message 914 to the sharing server.

The sharing server sends two control requested messages to the sharer computing device, such as messages 916 and 918. The control requested messages include the identities of the viewer computing devices that sent the request control messages. The sharer computing device adds indications of the received control requests to a queue 910, such as using operations 920 and 922.

The sharer retrieves 924 the next control request from the queue. The next control message can be the oldest message or a priority message that is stored in the queue. In the illustrated embodiment, the request control message received from viewer computing device 906, having identity 2, is the next control request.

The sharer computing device then sends 926 a set controller message identifying the identity of the next controller (e.g., 2) to the sharing server. The sharing server then sends a controller change message to all viewer computing devices participating in the application sharing session, such as messages 928 and 930. Thus, all viewer computing devices participating in the application sharing session are informed of the controller change.

In various embodiments, the sharer computing device can receive and send messages in lieu of the sharing server.

FIG. 10 is a control flow diagram illustrating control transfer in various embodiments. The illustrated control flow corresponds to transferring control to a requesting computing device that is participating in an application sharing session in which a different computing device presently has control.

Viewer computing device 906, which is presently controlling the application sharing session, sends 1002 mouse and keyboard messages to the sharing server. The sharing server may then forward 1004 the received mouse and keyboard messages to the sharer computing device.

The sharer computing device may detect that the controller has not sent any input messages within a defined period of time so that an inactivity timeout 1006 has occurred. When this occurs, the sharer computing device retrieves 1008 the next control request from the queue. The sharer computing device then sets the controller (e.g., having identity 3) by sending 1010 a set controller message to the sharing server. The sharing server may then send a controller change message identifying the new controller (e.g., having identity 3) to viewer computing devices participating in the application sharing session, such as messages 1012 and 1014. Thus, the viewer computing devices participating in the application sharing session are informed of the new controller's identity.

Although the subject matter has been described in language specific to structural features and/or methodological acts, it is to be understood that the subject matter defined in the appended claims is not necessarily limited to the specific features or acts described above. As an example, the facility can determine which of multiple requesting participants should receive control in various ways, such as round robin, time limits, or specific to each participant or the participants' use. In various embodiments, an installed or configured component can be provided that has arbitrary algorithms for selecting a participant. In some embodiments, control may return to a selected user after a defined period of time. In various embodiments, the arbiter can be distributed so that, for example, it can operate at participant computing devices. The specific features and acts described above are disclosed as example forms of implementing the claims. Accordingly, the invention is not limited except as by the appended claims.

We claim:

1. A method performed by a computer system for controlling application sharing, comprising:
sharing an application from a sharer computing device to a first viewer computing device so that the first viewer computing device displays information that the sharer computing device displays;
receiving a request from the first viewer computing device to control the sharing; and
transferring control of the shared application to the first viewer computing device without intervention by a user of the sharer computing device so that a user of the first viewer computing device can control the shared application.

2. The method of claim 1 further comprising receiving an indication from a second viewer computing device to control the sharing and transferring control of the shared application to the second viewer computing device without intervention by the user of the sharer computing device so that a user of the second viewer computing device can control the shared application.

3. The method of claim 2 wherein the transferring includes determining whether to provide control to the user of the second viewer computing device.

4. The method of claim 3 wherein the determining includes evaluating whether the user of the first viewer computing device has not provided any input in a defined period of time.

5. The method of claim 1 wherein the receiving includes receiving a message from the first viewer computing device, the message indicating a requester.

6. The method of claim 5 wherein the requester indicates the first viewer computing device.

7. The method of claim 1 further comprising adding the received indication from the first viewer computing device to a queue of received control requests.

8. The method of claim 7 wherein the receiving the indication to control the sharing includes receiving a message identifying the user of the second viewer computing device.

9. The method of claim 7 wherein the receiving the indication to control the sharing includes receiving a message identifying the second viewer computing device.

10. The method of claim 7 wherein the transferring includes sending a message to the first viewer computing device indicating that the second viewer computing device has control of the shared application.

11. The method of claim 1 wherein the transferring includes sending a message to the first viewer computing device indicating that it has control of the shared application.

12. A computer-readable medium having computer-executable instructions that, when executed, cause a computer system to perform a method for controlling application sharing, the method comprising:
receiving from a user at a viewer computing device an indication to control a shared application that is shared by a sharer computing device;
sending from the viewer computing device to the sharer computing device a request to control the shared application; and
receiving at the viewer computing device an indication that the viewer computing device has control of the shared application, the control having been transferred to the viewer computing device without intervention by a user of the sharer computing device.

13. The computer-readable medium of claim 12 wherein the sending includes sending from the viewer computing device a message to the sharer computing device requesting control of the shared application.

14. The computer-readable medium of claim 12 wherein the receiving includes receiving at the viewer computing device a message from the sharer computing device indicating that the viewer computing device has control of the shared application.

15. The computer-readable medium of claim 12 wherein the sharer computing device adds an indication of the control requests it receives to a queue of received control requests so that the sharer computing device can select one of several viewer computing devices that have sent control requests.

16. The computer-readable medium of claim 15 wherein the viewer computing device that sent the earliest control request in the queue receives control.

17. The computer-readable medium of claim 15 wherein the viewer computing device that sent a highest priority control request in the queue receives control.

18. A system for controlling application sharing, comprising:
an application sharing software component that shares an application; and
a component that receives from a viewer computing device a request to control a shared application, adds the received request to a queue of control requests, determines whether control can be provided to the viewer computing device and, when control can be provided to the viewer computing device, provides control to the viewer computing device without intervention from a user of a computing device that is associated with the application sharing software component.

19. The system of claim 18 wherein the computing device that is associated with the application sharing software component is a sharing server and the user that is associated with the application sharing software component uses a sharer computing device.

20. The system of claim 18 wherein the application sharing software component can share the shareable application or a document the shareable application opens.
